(19) United States
(12) Patent Application Publication
(10) Pub. No.: US 2018/0331455 A1
(43) Pub. Date: Nov. 15, 2018

(54) ELECTRICAL CONNECTOR WITH TOUCH PROTECTION FEATURE

(71) Applicant: Lear Corporation, Southfield, MI (US)

(72) Inventors: Bhupinder Rangi, Novi, MI (US); Yefim Grinshpun, Southfield, MI (US); Anthony Butcher, Troy, MI (US); David Menzies, Linden, MI (US)

(73) Assignee: Lear Corporation, Southfield, MI (US)

(21) Appl. No.: 15/592,974

(22) Filed: May 11, 2017

(51) Int. Cl. H01R 13/44; H01R 13/11

(52) U.S. Cl. CPC H01R 13/44; H01R 13/11

(57) ABSTRACT

An electrical connector includes a connector housing with a terminal cavity. The connector housing includes a non-conducting bridge. The non-conducting bridge is located in the terminal cavity.

### BACKGROUND OF THE INVENTION

The present invention relates in general to an electrical connector with a touch protection feature. More specifically, this invention relates to a touch protection feature that is part of the connector and protects a male electrical terminal installed in the connector from being touched.

Electrical connectors are used to house electrical terminals that are used in a variety of applications, including creating high-voltage and low-voltage connections. Corresponding terminals in corresponding connectors are mated with the electrical terminals. In many instances, it is desirable that a touch protection feature be provided in order to prevent a person from accidentally contacting the electrical terminal.

Touch protection features typically include electrically non-conductive pieces positioned between the electrical terminal and the person. One example of such a touch protection feature for a blade-type male electrical terminal is shown in U.S. Pat. No. 8,951,051, the disclosure of which is incorporated herein by reference. The '051 patent teaches a blade-shaped conductor with a non-conducting end cap secured to the tip. It would be advantageous to have a touch protection feature for a connector that is easier to assemble.

### SUMMARY OF THE INVENTION

This invention relates to an electrical connector. The electrical connector includes a connector housing with a terminal cavity. The connector housing includes a non-conducting bridge. The non-conducting bridge is located in the terminal cavity.

In another embodiment, this invention relates to an electrical connector assembly. The electrical connector assembly includes a connector housing with a terminal cavity. A male electrical terminal is located in the terminal cavity. The connector housing includes a non-conducting bridge. The non-conducting bridge is located in the terminal cavity. The electrical connector assembly also includes a corresponding connector housing. The corresponding connector housing includes a female electrical terminal. The female electrical terminal is adapted to mate with the male electrical terminal. The corresponding connector housing includes side walls on opposed sides of the female electrical terminal. Each of the side walls includes a slot. A portion of the non-conducting bridge is located in each slot when the female electrical terminal is engaged with the male electrical terminal.

In another embodiment, this invention relates to an electrical connector assembly. The electrical connector assembly includes a connector housing with a terminal cavity. A male electrical terminal is located in the terminal cavity. The connector housing includes a non-conducting bridge. The non-conducting bridge is located in the terminal cavity. The electrical connector assembly also includes a corresponding connector housing. The corresponding connector housing includes a female electrical terminal. The female electrical terminal is mated with the male electrical terminal. The corresponding connector housing includes side walls on opposed sides of the female electrical terminal. At least a portion of each of the side walls is located in the terminal cavity. Each of the side walls includes a slot. At least a portion of the non-conducting bridge located in each of the slots.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an electrical connection assembly.

FIG. 2 is a perspective view similar to FIG. 1, shown with a corresponding connector housing removed so that a mounted connector housing with two male terminal cavities is visible.

FIG. 3 is an enlarged view of the mounted connector housing.

FIG. 4 is a further enlarged, cross-sectional view of one terminal cavity of the mounted connector housing, taken along line 4-4 of FIG. 3.

FIG. 5 is a perspective, partially exploded view of the mounted connector housing and two male blade terminals illustrated in FIG. 3.

FIG. 6 is an enlarged, perspective, exploded view of the corresponding connector housing and two female terminal housings illustrated in FIG. 1.

FIG. 7 is a side view of the two female terminal housings illustrated in FIG. 6.

FIG. 8 is a cross-sectional view of the electrical connection assembly shown during connection of the corresponding connector housing to the mounted connector housing.

FIG. 9 is a cross-sectional view of the electrical connection assembly, taken along line 9-9 of FIG. 1, showing the final connection position of the corresponding connector housing to the mounted connector housing.

### DETAILED DESCRIPTION OF THE PREFERRED EMBODIMENT

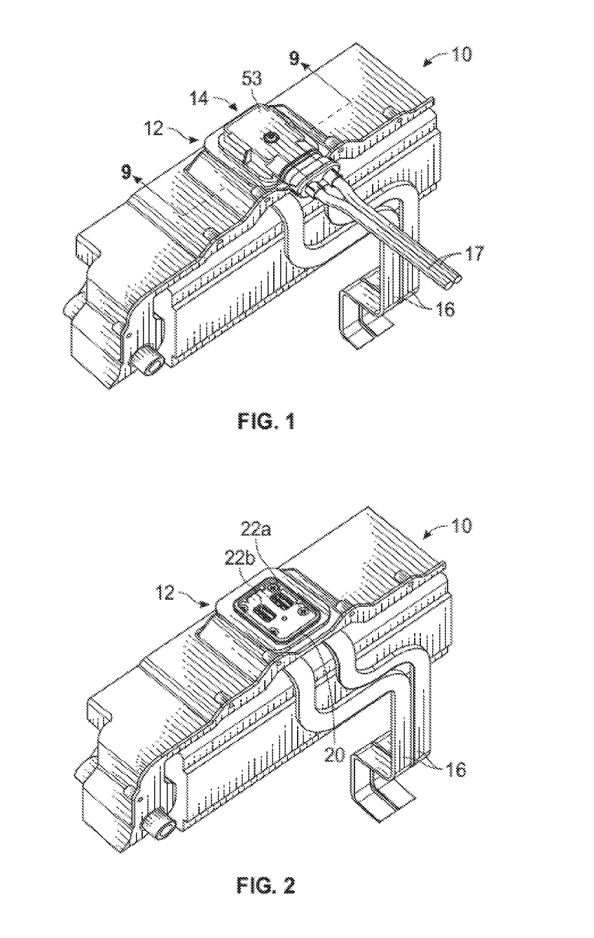

Referring now to the drawings, there is illustrated in FIG. 1 an electrical connection assembly, indicated generally at 10. The electrical connection assembly 10 includes a mounted connector, indicated generally at 12, and a corresponding connector, indicated generally at 14. The electrical connection assembly 10 allows two busbars 16 which are connected to the mounted connector 12, to be selectively connected to two wires 17 which are connected to the corresponding connector 14. The illustrated electrical connection assembly 10 is an example of one electrical connector which the invention described herein can be used with. However, the invention may be used with any desired electrical connector.

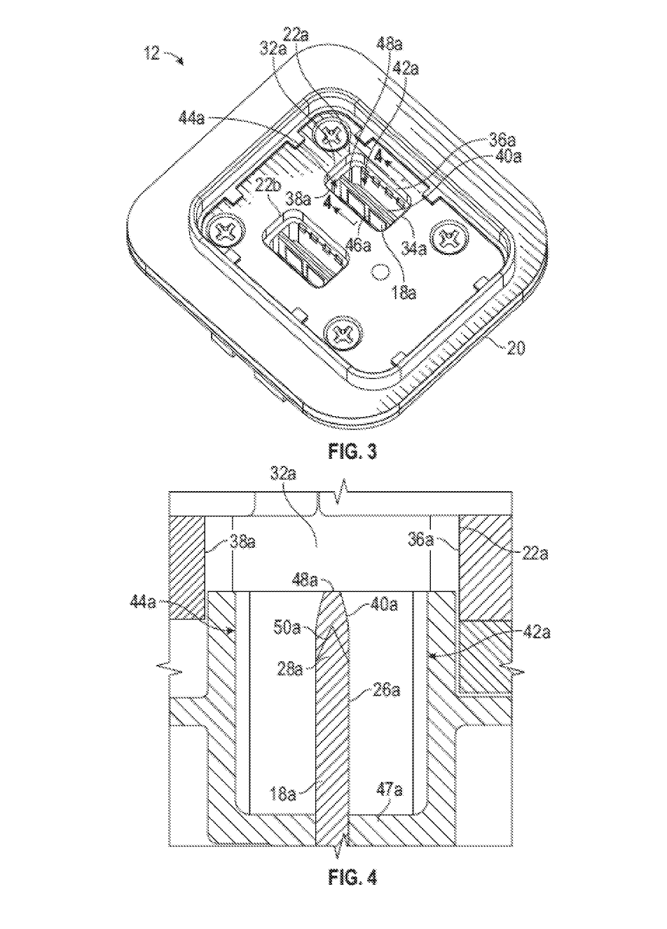

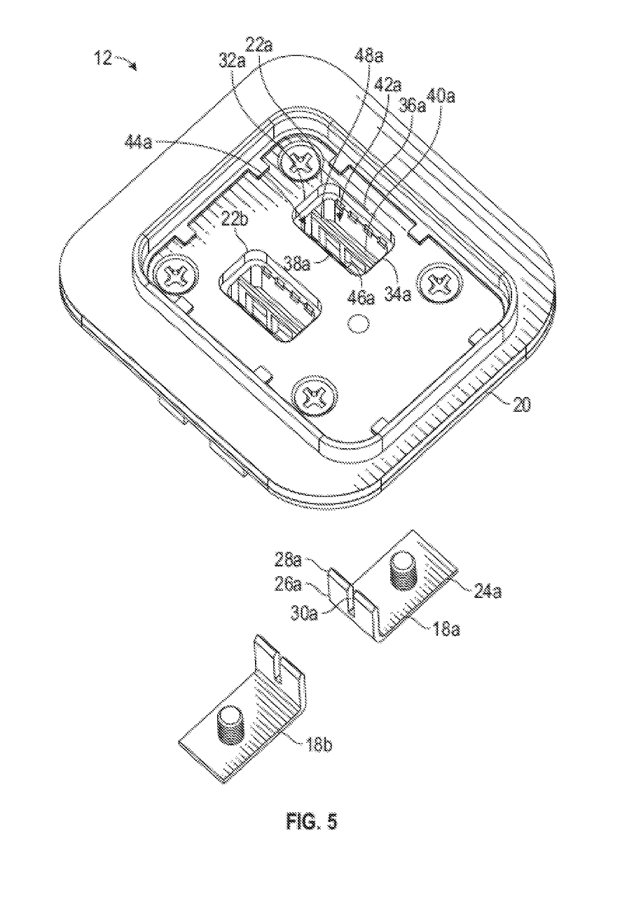

Referring now to FIG. 2, a view similar to that of FIG. 1 is illustrated, showing the electrical connection assembly 10 with the corresponding connector 14 removed so that the mounted connector 12 is more clearly visible. The mounted connector 12 will be described primarily in reference to FIGS. 3 through 5. Referring to FIG. 3, an enlarged view of the mounted connector 12 is shown, removed from the rest of the electrical connection assembly 10. FIG. 4 is a cross-sectional view taken through a portion of the mounted connector 12. FIG. 5 shows a partially-exploded view of the mounted connector 12, with two male terminals 18a and 18b removed from a connector housing 20.

The illustrated connector housing 20 is made of plastic, but may be made of any desired material. The connector housing 20 includes two terminal cavities 22a and 22b, but may include any desired number of terminal cavities. The two terminal cavities 22a and 22b are substantially the same, and only the terminal cavity 22a will be described in detail. Similarly, the two male terminals 18a and 18b are substantially the same, and only the male terminal 18a will be described in detail.

The male terminal 18a is made from a single piece of sheet copper, but may be made of any desired material and using any desired manufacturing process. The male terminal 18a includes a connection portion 24a and a contact portion 26a. The illustrated connection portion 24a is adapted to be connected to one of the busbars 16 using a threaded connector. However, the connection portion 24a may be any desired type of connector. The illustrated contact portion 26a is a blade-type terminal, but may have any desired shaped. The male terminal 18a generally L-shaped, with the contact portion 26a bent substantially perpendicular to the connection portion 24a. However, the male terminal 18a may have any desired shaped. The contact portion 26a extends from the connection portion 24a to an outer end 28a. The illustrated outer end 28a tapers to a point, but the outer end 28a may have any desired shape. The contact portion 26a includes an optional slot 30a. The slot 30a extends from the outer end 28a toward the connection portion 24a. The purpose of the slot 30a will be described below.

The illustrated terminal cavity 22a is defined in the connector housing 20 and has a generally rectangular cross-sectional shape, but may have any desired cross-sectional shape. The terminal cavity 22a includes a first two opposed side walls 32a and 34a, and a second two opposed side walls 36a and 38a. The terminal cavity 22a includes a non-conducting bridge 40a that is connected to the connector housing 20. The illustrated non-conducting bridge 40a extends from the side wall 32a to the opposed side wall 34a. The illustrated non-conducting bridge 40a is made of plastic and is molded as a part of the connector housing 20. However, the non-conducting bridge 40a may be made of any desired material and by any desired process. The non-conducting bridge 40a may be a separate piece that is connected to the connector housing 20, if desired. A first opening, indicated at 42a, is defined between the non-conducting bridge 40a and the side wall 36a, and a second opening, indicated at 44a, is defined between the non-conducting bridge 40a and the opposed side wall 38a.

As best seen in FIG. 5, the connector housing 20 includes an optional strut 46a which extends from the non-conducting bridge 40a to a bottom 47a of the terminal cavity 22a. The illustrated strut 46a is made of plastic and is molded as a part of the connector housing 20. However, the strut 46a may be made of any desired material and by any desired process. The strut 46a provides support for the non-conducting bridge 40a prior to the male terminal 18a being installed in the terminal cavity 22a. In the event that pressure is applied to the non-conducting bridge 40a during assembly, the strut 46a can support the load to help prevent damage to the non-conducting bridge 40a. When the male terminal 18a is installed in the terminal cavity 22a, the strut 46a is located in the slot 30a of the male terminal 18a, as shown in FIG. 3. The illustrated connector housing 20 includes a single strut 46a, but may include any desired number of struts.

As best seen in FIG. 4, the non-conducting bridge 40a includes an outer bridge end 48a. The illustrated outer bridge end 48a tapers to a point, but the outer bridge end 48a may have any desired shape. The non-conducting bridge 40a also includes a recess 50a on the opposed side of the non-conducting bridge 40a. The illustrated recess 50a has a V-shape, but may have any desired shape. When the illustrated male terminal 18a is installed in the connector housing 20, it is inserted into the terminal cavity 22a, as shown in FIG. 3. The outer end 28a of the connection portion 24a enters the recess 50a in the non-conducting bridge 40a in order to assist in the proper alignment of the connection portion 24a with the non-conducting bridge 40a.

Referring back to FIG. 3, it can be seen that the non-conducting bridge 40a provides a touch protection feature for the mounted connector 12. The male terminal 18a may be contacted by an object small enough to fit through the first opening 42a or the second opening 44a, but larger objects are prevented from contacting the male terminal 18a. The sizes of the opening 42a and the opening 44a may be selected to exclude objects of any desired size. The illustrated non-conducting bridge 40a is made of a non-electrically conductive material. However, the non-conducting bridge 40a may be made of any desired material and may, for example, include a non-conducting layer or coating.

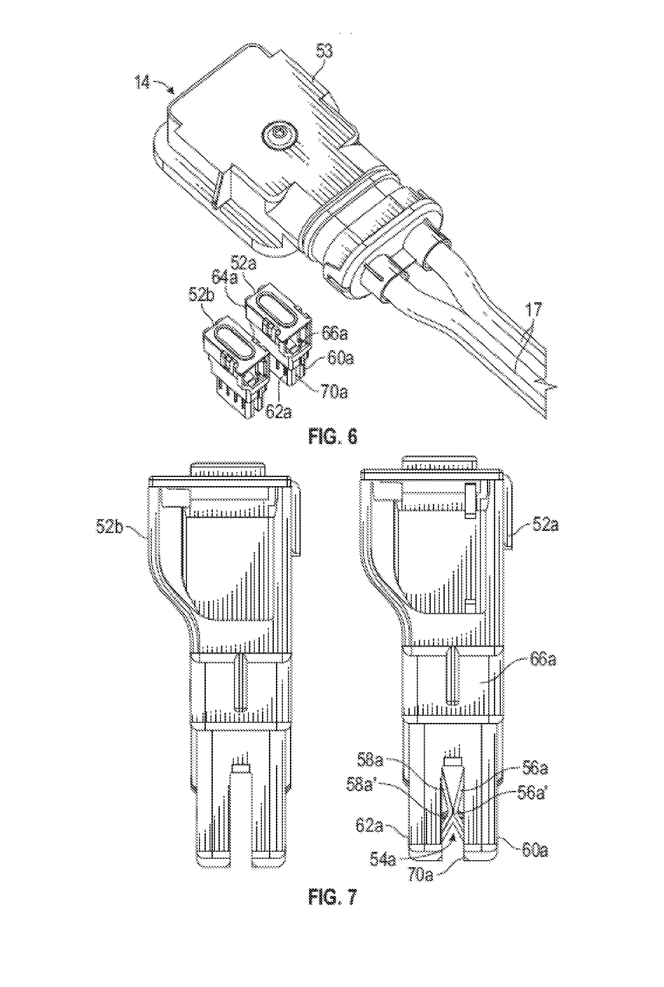

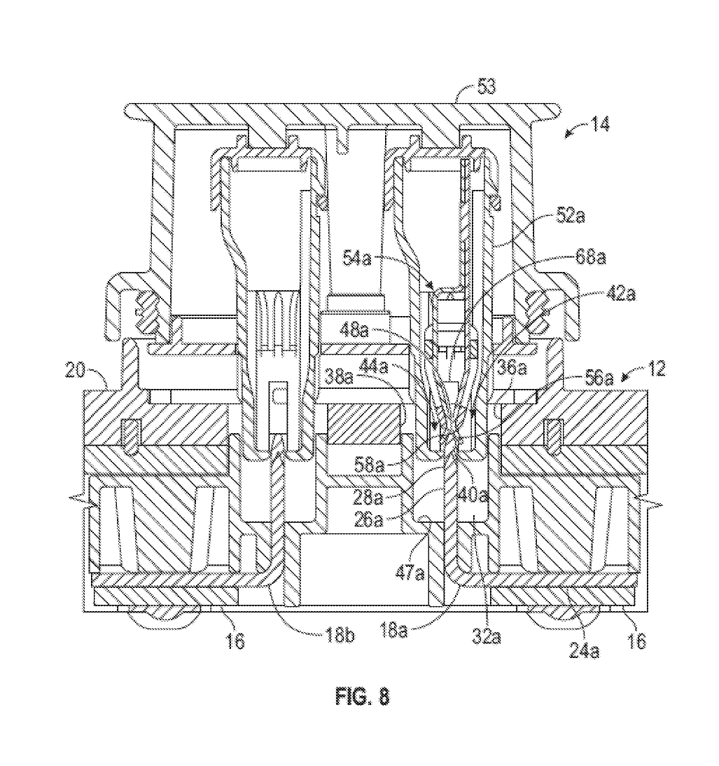

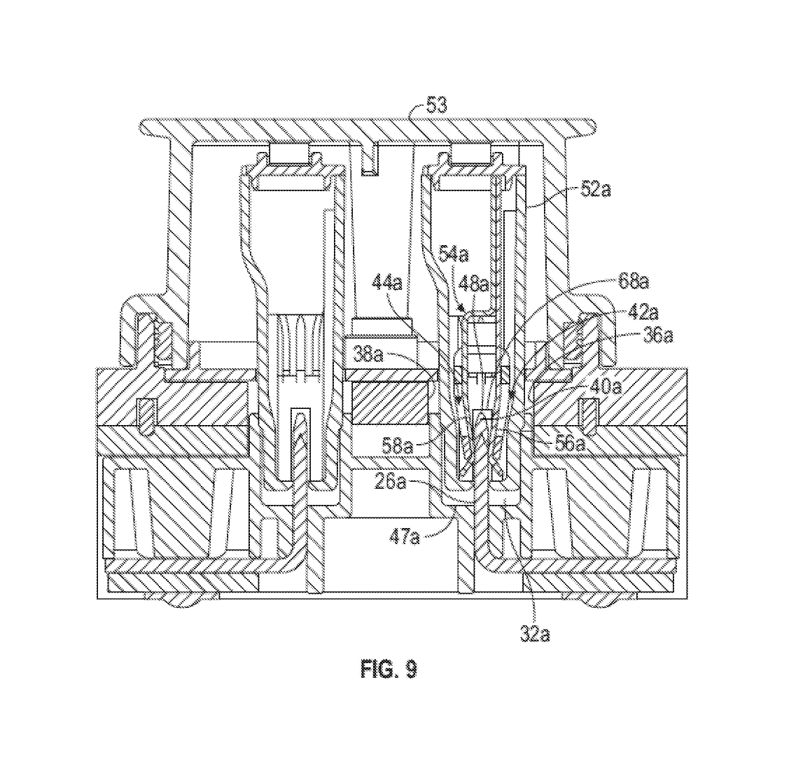

Referring now to FIG. 6, a perspective view of the corresponding connector 14 is shown, partially-exploded with two female terminal housings 52a and 52b shown removed from a corresponding connector housing 53. The female terminal housings 52a and 52b will be described primarily in reference to FIGS. 6 through 9. Referring to FIG. 7, a side view of the two female terminal housings 52a and 52b is shown. The two female terminal housings 52a and 52b are substantially the same, and only the female terminal housing 52a will be described in detail. The female terminal housing 52a is shown with a female terminal, indicated generally at 54a, mounted therein. The female terminal housing 52b is shown without a female terminal, so that features of the female terminal housing 52b are more easily visible. Referring to FIG. 8, a cross-sectional view of the electrical connection assembly 10 is illustrated, shown during initial connection of the assembled corresponding connector 14 to the mounted connector 12.

The female terminal 54a includes opposed contact arms 56a and 58a, which are adapted to engage the male blade terminal 18a. The contact arms 56a and 58a include respective contact areas, 56a′ and 58a′, which will contact the male terminal 18a. In the illustrated embodiment, the contact areas 56a′ and 58a′ are initially in contact with each other. However, the contact areas 56a′ and 58a′ may be spaced apart with a gap therebetween, if desired. The contact arms 56a and 58a will spread apart when engaged by a male blade terminal, as is well known in the art. The contact arms 56a and 58a will spread apart toward respective, opposed side walls 60a and 62a of the female terminal housing 52a. The female terminal housing 52 also includes opposed sides walls 64a and 66a, which are generally perpendicular to opposed side walls 60a and 62a. The opposed side walls 64a and 66a include respective slots 68a and 70a. The slots 68a and 70a define a space therebetween, and the contact areas, 56a′ and 58a′ are located in this space between the slots 68a and 70a. This is best shown in FIG. 7, where the contact areas 56a′ and 58a′ are visible through the slot 70a when viewed perpendicularly to the side wall 66a.

As shown in FIG. 8, during initial connection of the corresponding connector 14 to the mounted connector 12, the non-conducting bridge 40a passes through the slots 68a and 70a and engages the contact arms 56a and 58a. As the corresponding connector 14 is moved farther toward the mounted connector 12, the contact arms 56a and 58a will be spread apart by the non-conducting bridge 40a and will pass through the first and second openings 42a and 44a. The contact arms 56a and 58a will slide along the non-conducting bridge 40a until they engage the male terminal 18a. The female terminal 54a will then be in electrical contact with the male terminal 18a. As previously described, the outer end 28a of the connection portion 24a is positioned in the recess 50a in the non-conducting bridge 40a in order to assist in the proper alignment of the connection portion 24a with the non-conducting bridge 40a. This helps to ensure that the contact arms 56a and 58a can smoothly slide from the non-conducting bridge 40a onto the male terminal 18a without damaging any of the components.

The principle and mode of operation of this invention have been explained and illustrated in its preferred embodiment. However, it must be understood that this invention may be practiced otherwise than as specifically explained and illustrated without departing from its spirit or scope.

1. An electrical connector comprising:
a connector housing including a terminal cavity; and
a non-conducting bridge connected to the connector housing and located in the terminal cavity.

2. The electrical connector of claim 1, further comprising a male electrical terminal located in the terminal cavity, wherein the male electrical terminal extends to an outer end that is adjacent to the non-conducting bridge.

3. The electrical connector of claim 1, wherein the non-conducting bridge extends between two opposed side walls of the terminal cavity.

4. The electrical connector of claim 3, further including openings defined between the non-conducting bridge and a second two opposed side walls of the terminal cavity.

5. The electrical connector of claim 1, further including a strut that extends from the non-conducting bridge to a bottom surface of the terminal cavity.

6. The electrical connector of claim 5, wherein the male electrical terminal includes a slot and the strut is located in the slot.

7. The electrical connector of claim 2, wherein the non-conducting bridge includes a recess, and an outer end of the male electrical terminal is located in the recess.

8. The electrical connector of claim 7, wherein the outer end of the male electrical terminal tapers to a point.

9. The electrical connector of claim 8, further including a strut that extends from the non-conducting bridge to a bottom surface of the terminal cavity.

10. The electrical connector of claim 9, wherein the male electrical terminal includes a slot and the strut is located in the slot.

11. An electrical connector assembly comprising:
a connector housing including a terminal cavity;
a male electrical terminal located in the terminal cavity;
a non-conducting bridge connected to the connector housing and located in the terminal cavity;
a corresponding connector housing including a female electrical terminal, which is adapted to mate with the male electrical terminal; and
the corresponding connector housing including side walls on opposed sides of the female electrical terminal, each of the side walls including a respective slot, wherein a portion of the non-conducting bridge is adapted to be located in each of the slots when the female electrical terminal is engaged with the male electrical terminal.

12. The electrical connector assembly of claim 11, wherein the non-conducting bridge extends between two opposed side walls of the terminal cavity.

13. The electrical connector assembly of claim 12, wherein the non-conducting bridge includes a recess and an outer end of the male electrical terminal is located in the recess.

14. The electrical connector assembly of claim 13, wherein the outer end of the male electrical terminal tapers to a point.

15. The electrical connector assembly of claim 14, further including a strut that extends from the non-conducting bridge to a bottom surface of the terminal cavity.

16. The electrical connector assembly of claim 15, wherein the male electrical terminal includes a slot and the strut is located in the slot.

17. An electrical connector assembly comprising:
a connector housing including a terminal cavity;
a male electrical terminal located in the terminal cavity;
a non-conducting bridge connected to the connector housing and located in the terminal cavity;
a corresponding connector housing including a female electrical terminal, which is mated with the male electrical terminal; and
the corresponding connector housing including side walls on opposed sides of the female electrical terminal, at least a portion of each of the side walls located in the terminal cavity, each of the side walls including a respective slot, at least a portion of the non-conducting bridge located in each of the slots.
